(19) United States
(12) Patent Application Publication
(10) Pub. No.: US 2022/0067518 A1
(43) Pub. Date: Mar. 3, 2022

(54) DATA PROCESSING METHOD, DATA PROCESSING APPARATUS, AND COMPUTER-READABLE STORAGE MEDIUM

(71) Applicant: Preferred Networks, Inc., Tokyo (JP)

(72) Inventor: Gentaro WATANABE, Tokyo (JP)

(21) Appl. No.: 17/445,755

(22) Filed: Aug. 24, 2021

(30) Foreign Application Priority Data
Aug. 26, 2020 (JP) 2020-142827

(51) Int. Cl. G06N 3/08; G06N 3/04; G06F 7/535

(52) U.S. Cl. CPC G06N 3/08; G06F 7/535; G06N 3/0445

(57) ABSTRACT

A data processing method includes a first processing which executes a first computation using first data to obtain second data, a second processing which executes a second computation using the second data, and storing, in a memory, the second data having a storing value greater than or equal to a predetermined storing value. The storing value is determined based on a cost of the first computation and a size of the second data.

### CROSS-REFERENCE TO RELATED APPLICATIONS

This application is based upon and claims priority to Japanese Patent Application No. 2020-142827, filed on Aug. 26, 2020, the entire contents of which are incorporated herein by reference.

### BACKGROUND

### 1. Technical Field

The present disclosure is related to data processing methods, data processing apparatuses, and computer-readable storage media.

### 2. Description of the Related Art

Typically, a training in deep learning is performed using a processor having multiple cores, such as Graphics Processing Units (GPUs) or the like. When the training is performed using the processor of this type, an intermediate computation result of a forward processing is typically stored in an external memory, such as a Dynamic Random Access Memory (DRAM) or the like, for use in executing a backward processing. When executing the backward processing, the intermediate computation result (or internal data) of the forward processing required for the computation of the backward processing is read from the external memory. The intermediate computation result of the forward processing can be stored in the external memory each time, because a memory bandwidth (or communication bandwidth) between the processor and the external memory can be sufficiently large.

When a performance of the processor improves, it may become difficult to secure the memory bandwidth, which is sufficiently large for enabling transmission of the intermediate computation result of the forward processing to the external memory each time, between the processor and the external memory. If it is difficult to improve the memory bandwidth by utilizing the external memory or a memory interface having an existing configuration, development or the like of a new high-speed memory or a new high-speed memory interface may become required, thereby greatly increasing a system cost.

### SUMMARY

A data processing method according to one embodiment of the present invention includes a first processing which executes a first computation using first data to obtain second data; a second processing which executes a second computation using the second data; and storing, in a memory, the second data having a storing value greater than or equal to a predetermined storing value, wherein the storing value is determined based on a cost of the first computation and a size of the second data.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a block diagram illustrating an example of a data processing apparatus according to one embodiment of the present invention.

FIG. 2 is a diagram for explaining an example of a training of a neural network performed by the data processing apparatus illustrated in FIG. 1.

FIG. 3 is a flow diagram illustrating an example of a forward processing in the training of the neural network.

FIG. 4 is a flow diagram illustrating an example of a backward processing and an optimization processing in the training of the neural network.

FIG. 5 is a diagram for explaining the example of the training of the neural network by the data processing apparatus illustrated in FIG. 1.

FIG. 6 is a diagram for explaining another example of the training of the neural network by the data processing apparatus illustrated in FIG. 1.

FIG. 7 is a diagram for explaining still another example of the training of the neural network by the data processing apparatus illustrated in FIG. 1.

FIG. 8 is a diagram for explaining another example of the training of the neural network by the data processing apparatus illustrated in FIG. 1.

FIG. 9 is a flow diagram illustrating an example of an operation of the data processing apparatus which performs the training of the neural network.

FIG. 10 is a block diagram illustrating an example of a hardware configuration of the data processing apparatus illustrated in FIG. 1.

### DETAILED DESCRIPTION

Embodiments of the present invention will be described in detail, with reference to the drawings.

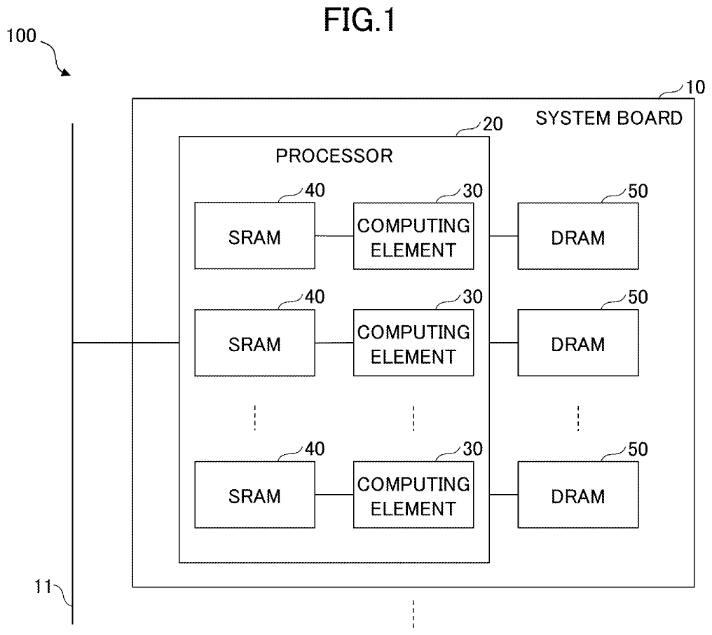

FIG. 1 is a block diagram illustrating an example of a data processing apparatus according to one embodiment of the present invention. A data processing apparatus 100 illustrated in FIG. 1 may have at least one system board 10 including a processor 20, and multiple Dynamic Random Access Memories (DRAMs) 50 connected to the processor 20. For example, the data processing apparatus 100 may be a server. The processor 20 is an example of an arithmetic element. The DRAM 50 is an example of a memory (or external memory).

The processor 20 may include multiple computing elements 30, and multiple Static Random Access Memories (SRAMs) 40 respectively connected to the multiple computing elements 30. The processor 20 may be connected to a system bus 11. The processor 20 may take the form of a chip or a package. The DRAM 50 is an example of a memory connected to the processor 20, and the SRAM 40 is an example of a memory connected to the processor 30. The SRAM 40 is an example of an internal memory.

Hence, in this embodiment, the data processing apparatus 100 includes multiple types of memories having different read and write speeds, that is, the SRAMs 40, and the DRAMs 50 having read and write speeds that are generally slower than the read and write speeds of the SRAMs 40. In this embodiment, when performing a training of a neural network having multiple layers, for example, it is possible to compensate for the insufficient read and write speeds of the memory, by not writing a part of computation results of some of the layers to the DRAMs 50, thereby improving the training speed.

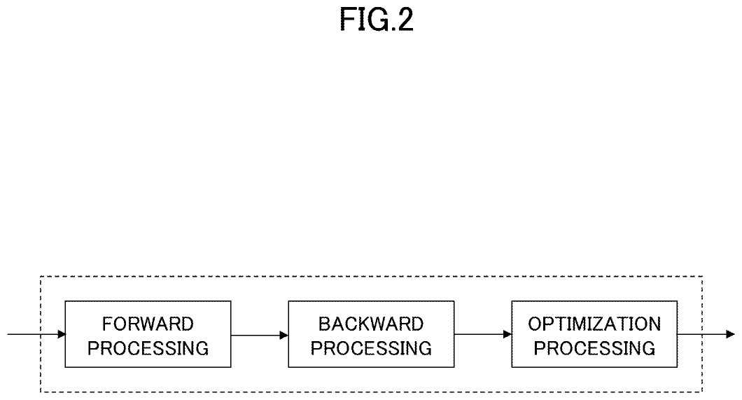

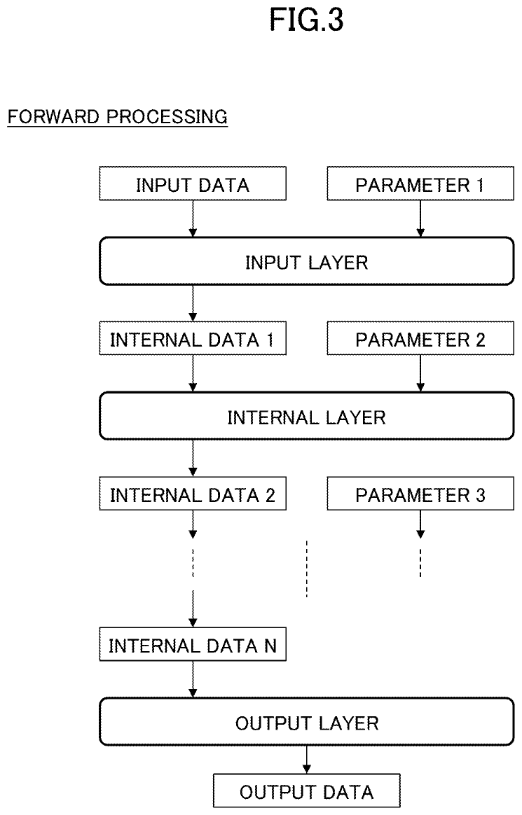

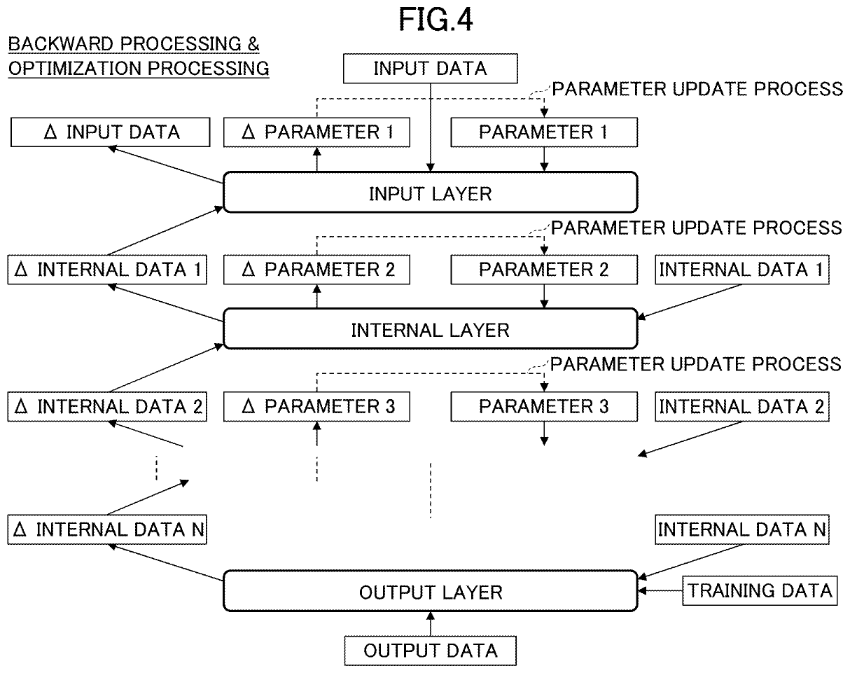

FIG. 2 is a diagram for explaining an example of the training of the neural network performed by the data processing apparatus 100 illustrated in FIG. 1. In the training of the neural network having multiple internal layers (or hidden layers) between an input layer and an output layer, a forward processing, a backward processing, and an optimization processing may be repeated multiple times while varying training data. The forward processing, the backward processing, and the optimization processing will be described in conjunction with FIG. 3 and FIG. 4.

The forward processing is an example of a first processing, and computations executed in the multiple layers (that is, the multiple internal layers) in the forward processing are an example of multiple kinds of first computations. First data are an example of data used in the first computation, and second data are an example of data (or computation result) obtained by executing the first computation. The backward processing is an example of the second processing, and computations executed in the multiple layers in the backward processing are an example of multiple kinds of second computations.

FIG. 3 is a flow diagram illustrating an example of the forward processing in the training the neural network. In the forward processing, a parameter, such as data, weight, or the like, may be input to each of the input layer and a predetermined number of internal layers. The input layer may execute computations on input data and a parameter 1, thereby generating internal data 1. The internal layer next to the input layer may execute computations on the internal data 1 and a parameter 2, thereby generating internal data 2.

Each of subsequent internal layers may execute computations on internal data generated by a preceding internal layer, which may precede the internal layer of interest by one layer, and the parameter set for each internal layer, thereby generating internal data to be output to a next internal layer, which may succeed the internal layer of interest by one layer. In some cases, one of the internal layers may not use the parameter. Examples of the internal layers may include a convolutional layer, a pooling layer, a fully connected layer, or the like.

The output layer obtains output data, by using internal data N generated by an internal layer N (Nth layer) which may precede the output layer by one layer. In the output layer which may obtain an error of a classification problem, the output data (or solution) may be obtained by using the softmax function as an activation function, and using the cross entropy as an error function, for example. As will be described later in conjunction with FIG. 4, the output layer may obtain an error (or loss function) between the output data and the correct answer by comparing the output data with training data (or correct answer data).

Hence, in the forward processing, each layer of the neural network may execute a computation on the input data and the parameter to obtain the data to be input to the next layer, and the output data may be output from the last layer (forward propagation). The forward processing may be used not only for the training of the neural network, but also for inference using the neural network. The forward processing can be represented by a computational graph, such as Directed Acyclic Graph (DAG) or the like.

FIG. 4 is a flow diagram illustrating an example of the backward processing and the optimization processing in the training of the neural network. The backward processing may perform a backpropagation which propagates the error in an order in reverse to the forward processing. In FIG. 4, a symbol Δ indicates an error of the data or an error of the parameter. A parameter update process performed by the optimization processing is indicated by a dashed arrow.

First, in the backward processing, the output data generated by the forward processing and the training data are compared in the layer (output layer) for obtaining the error, to generate Δ internal data N, which is the error with respect to the internal data N input to the output layer. The Δ internal data N is also the error of the output data output from the Nth internal layer.

Next, in each internal layer, a computation may be executed on the error (Δ internal data) with respect to the output layer, and the internal data which may be the input data, in an order starting from the internal layer close to the output layer, to generate a Δ parameter which may be the error with respect to the parameter of the internal layer of interest. The Δ parameter may indicate a gradient of the parameter of a curve representing the change in error with respect to the change in parameter. For example, in the internal layer adjacent to the input layer, a computation may be executed on Δ internal data 2 and the internal data 1, thereby obtaining a Δ parameter 2.

In each internal layer, the computation may be executed on the error (Δ internal data) with respect to the output data, and the parameter of the internal layer of interest, to generate the Δ internal data which may be the error with respect to the input data of the internal layer of interest. The error (Δ internal data) with respect to the input data of the internal layer of interest may be also the error of the output data of the preceding internal layer (or input layer) which may precede the internal layer of interest by one layer. For example, in the internal layer adjacent to the input layer, the computation may be executed on the Δ internal data 2 and the parameter 2, thereby obtaining the Δ internal data 1.

Similar to the internal layer, in the input layer, the computation may be executed on the Δ internal data 1 and the input data, thereby obtaining the Δ parameter 1, and the computation may be executed on the Δ internal data 1 and the parameter 1, thereby obtaining the Δ input data which may be the error with respect to the input data. Hence, the backward processing may require the internal data, which may be intermediate computation results of the forward processing.

In the optimization processing, the parameter may be corrected in each internal layer and the input layer, using the Δ parameter (gradient of the error) obtained by the backward processing. That is, the parameters may be optimized. The parameter optimization may be performed using the gradient descent method, such as Momentum-Stochastic Gradient Descent (Momentum-SGD), ADAM, or the like.

Accordingly, the backward processing may compute the error of the data (the output data of the internal layer preceding the output layer by one layer) input to the output layer, from the output data and the training data. Then, the process of computing the error of the internal data using the computed error of the data, and the process of computing the error of the parameter using the error of the internal data, may be performed in an order starting from the layer on the output side (backpropagation). The parameter update process may optimize the parameter, based on the error of the parameter obtained by the backward processing.

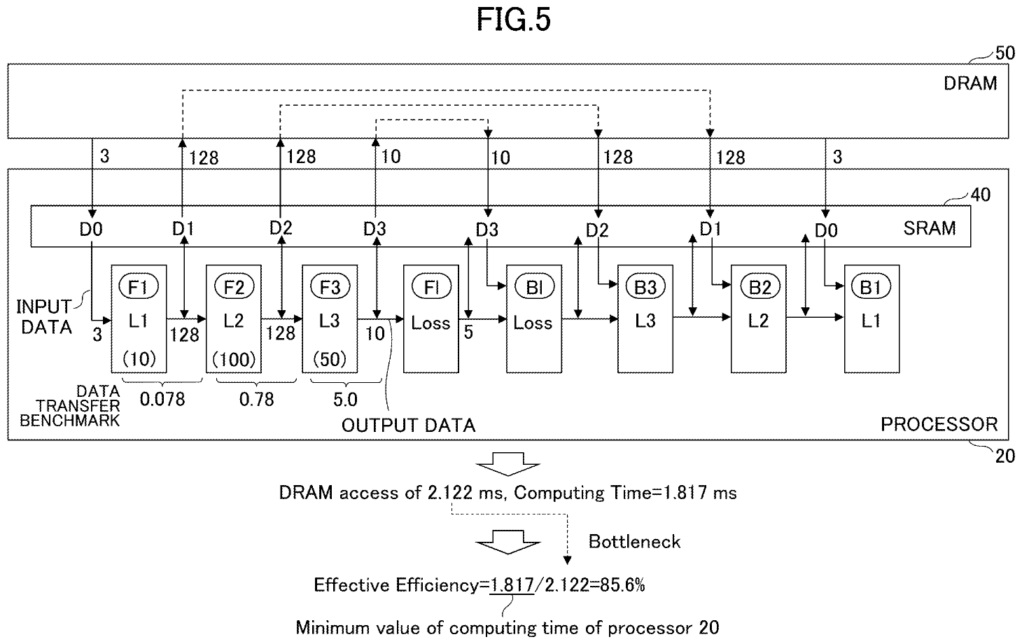

FIG. 5 through FIG. 8 are diagrams for explaining examples of the training of the neural network by the data processing apparatus 100 illustrated in FIG. 1. For the sake of simplifying the description and facilitating the understanding thereof, it is assumed that the neural network to be trained includes layers L1, L2, and L3, and a layer Loss. In the computational graph, the layer L1 receives input data D0, and an output of the layer L1 is connected to an input of the layer L2. An output of the layer L2 is connected to an input of the layer L3, and the layer L3 outputs output data. The layer Loss computes an error (loss function), using output data D3 from the layer L3 and training data. The description of FIG. 5 through FIG. 8 is based on the following assumptions (1) through (4).

(1) Generally, the deep learning collectively processes multiple data points in units called batches. Because a ratio of the computation and memory access is studied in FIG. 5 through FIG. 8, it may be regarded sufficient to discuss a peak performance and a memory bandwidth of the data processing apparatus 100 (processor 20) in terms of a value per data point included in one batch. The data size, Floating-point Operations Per Second (FLOPS), and memory bandwidth may implicitly be regarded as values per data point.

(2) It is assumed that the layer L1 is a convolutional layer with a kernel size of 1×1, a number of input channels (hereinafter also referred to as “an input channel number”) which is “3”, and a number of output channels (hereinafter also referred to as “an output channel number”) which is “128”. It is assumed that the layer L2 is a convolutional layer with a kernel size of 3×3, an input channel number which is “128”, and an output channel number which is “128”. It is assumed that the layer L3 is a fully connected layer with an input channel number which is “128”, and an output channel number which is “10”. Image sizes of the input and output of the layer L1, and an image size of the output of the layer L2 are 32 pixels wide and 32 pixels high, respectively.

(3) It is assumed that an appropriate activation function, such as a Rectified Linear Unit (ReLU) or the like, is inserted as an additional layer after each of the layers L1 and L2 (convolutional layers). It is further assumed that an Average Pooling (AP) is inserted before the layer L3 (fully connected layer). Each of the layers L1 and L2 may be a combination of a convolutional layer and a Rectified Linear Unit (ReLU). The layer L3 may be a combination of an Average Pooling (AP) and a fully connected layer.

Accordingly, in the trained neural network in FIG. 5, it is possible to execute a practical image recognition task, although on a relatively small scale. It is assumed that the forward processing and the backward processing can be executed by merging the layers L1, L2, and L3, respectively. That is, additional access to the DRAM 50 by these layers will not occur. In addition, it is assumed that an amount of computations executed by the additional layer is sufficiently small and negligible.

(4) The data used for the training may be expressed by a 32-bit floating-point format. It is assumed that a peak performance of processor 20 is 0.5 Tera Floating-point Operations Per Second (TFLOPS). It is assumed that a bandwidth of the processor 20 with respect to the DRAM 50 is 1 GB/s. It is assumed that the access to the DRAM 50 and the computation by the computing element 30 can overlap to a maximum. That is, a total elapsed time required for the training is the greater one of an access time of the DRAM 50 and a computing time of the computing element 30.

In FIG. 5 through FIG. 8, a combination of a reference character and a reference numeral, which is encircled inside each of the blocks indicating the layers L1, L2, L3, and Loss, represents the processing of each layer. A reference character “F” preceding the reference numeral represents the forward processing, and a reference character “B” preceding the reference numeral represents the backward processing. A numerical value in brackets, inside the each of the blocks indicating the layers L1, L2, and L3, represents an example of the cost (computing cost or operation cost) required by the processing in each layer.

In the forward processing, the numerical value input or output with respect to each of the layers L1, L2, L3, and Loss indicates the data size. In this example, for the sake of simplifying the description and facilitating the understanding thereof, it is assumed that the data size is the same as the number of channels between two mutually adjacent layers.

In the forward processing, a data transfer benchmark illustrated below each of the layer L1, L2, and L3 is obtained by dividing the computing cost of each layer by the data size output by each layer. The data transfer benchmark is one of criteria used to decide whether or not to transfer the data obtained by the forward processing of each layer to the DRAM 50, and is an example of a storing value which indicates the value of storing the data, that is, how valuable the storing of the data is. The storing value is sometimes also referred to as a transfer value which indicates the value of transferring the data for storage, that is, how valuable the transferring of the data for storage is.

The higher the storing value of the layer may be, the more preferable the data obtained by the computation may be transferred to the DRAM 50, and the lower the storing value of the layer may be, the more preferable the data obtained by the computation may not be transferred to the DRAM 50. Then, by determining whether or not to transfer the data for each layer to the DRAM 50, based on the storing value which indicates the value of storing the data, it is possible to improve an effective efficiency represented by a ratio of the computing time of the processor 20 to the elapsed time required for training the neural network. For example, the effective efficiency may be computed by dividing a minimum value (fastest value) of the computing time of the processor 20 by the elapsed time required for training the neural network. In FIG. 5 through FIG. 8, the amount of data temporarily stored in the SRAM 40 for use by the computation in each layer is not particularly limited. In addition, the data may be read from and written to the DRAM 50 via the SRAM 40.

In the training illustrated in FIG. 5, a threshold value of the data transfer benchmark, which determines whether or not to transfer the data obtained by the computation in each layer is to be transferred to the DRAM 50, may not be set. For this reason, in the forward processing, all of data D1, D2, and D3 respectively obtained by the computations in the layers L1, L2, and L3, are stored in the DRAM 50. Data D0 used in the layer L1 may be transferred from the DRAM 50. In the backward processing, the data D3, D2, D1, and D0 respectively used in the layers Loss, L3, L2, and L1, may be transferred from the DRAM 50.

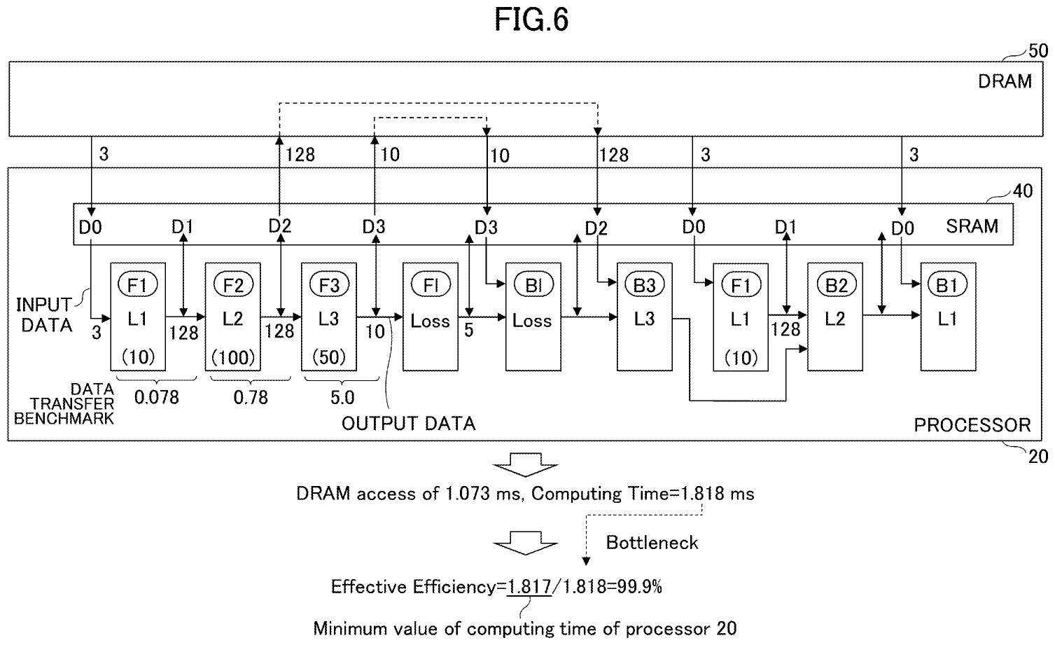

In this example, when all of the data obtained by the computations of the forward processing are stored in the DRAM 50, and all of the data used in the backward processing may be read from the DRAM 50, a total access time of the DRAM 50 during the entire training may become 2.122 ms. In addition, a total computing time of the processor 20 during the entire training may become 1.817 ms. Because the total computing time does not include recomputing of the data which will be described later in conjunction with FIG. 6 and the subsequent figures, the total computing time may become a minimum value. For this reason, the elapsed time required for the training may become the total access time (2.122 ms) of the DRAM 50, which becomes a bottleneck, and the effective efficiency may become 85.6% (1.817/2.122).

In the training illustrated in FIG. 6, the threshold value (first threshold value) of the data transfer benchmark, which determines whether or not the data obtained by the computation in each layer is to be transferred to the DRAM 50, may be set to “0.1”. Hence, in the forward processing, the data D2 and D3 obtained by the computations in the layers L2 and L3 having the data transfer benchmark greater than or equal to the threshold value, may be stored in the DRAM 50. The data D1 obtained by the computation in the layer L1 having the data transfer benchmark smaller than the threshold value may not be stored in DRAM 50. That is, the data processing apparatus 100 decimates a part of the data used for the training, and may store the decimated data in the DRAM 50.

In the backward processing, the data D1 used for the computation in the layer L2 may be recomputed by the processor 20 which executes the forward processing of the layer L1. The data D3, D2, and D0 used for the computations in the layers Loss, L3, and L1 of the backward processing are transferred from the DRAM 50.

In FIG. 6, the data D1 including a relatively large amount of data in the backward processing is recomputed by the forward processing F1 of the layer L1. Because there is no read or write of the data D1 with respect to the DRAM 50, the access time of the DRAM 50 during the entire training can be greatly reduced compared to FIG. 5, and the total access time becomes 1.073 ms. In addition, the total computing time of the processor 20 during the entire training slightly increases to 1.818 ms. Accordingly, the elapsed time required for the training becomes the total computing time (1.818 ms) of the processor 20, which becomes a bottleneck, and the effective efficiency becomes 99.9% (1.817/1.818) which is improved from the example of FIG. 5.

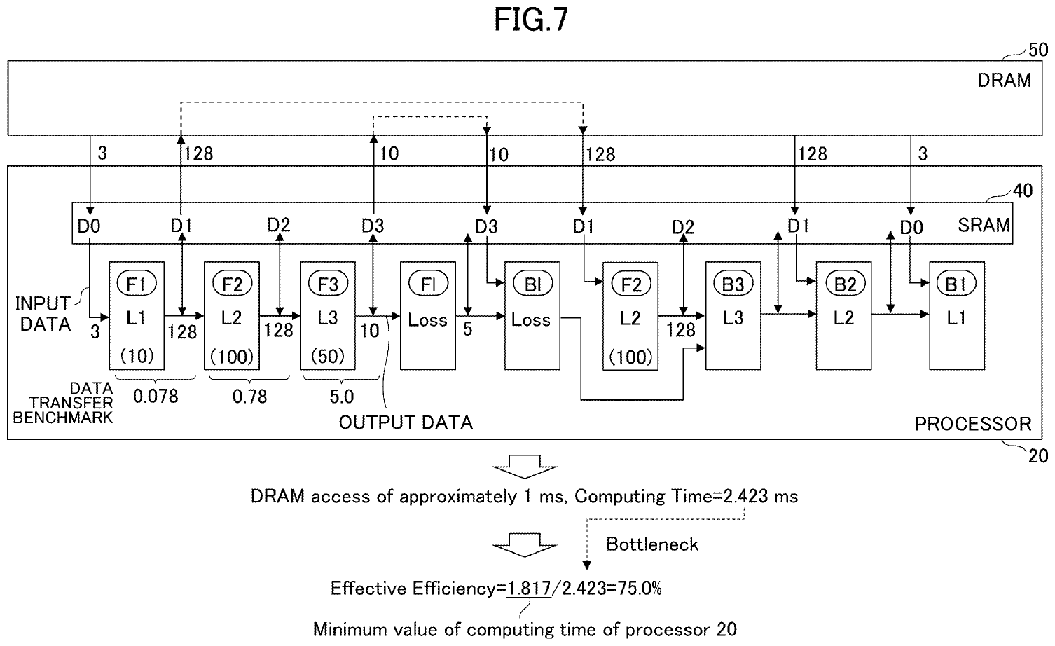

In the training illustrated in FIG. 7, the threshold value of the data transfer benchmark, which determines whether or not the data obtained by the computation in each layer is to be transferred to the DRAM 50, is set to “1.0”. However, in FIG. 7, in order to evaluate the effective efficiency, the data D1 obtained by the computation in the layer L1 having the data transfer benchmark smaller than the threshold value, is transferred to the DRAM 50. For this reason, in the forward processing, the data D3 obtained by the computation in the layer L3 having the data transfer benchmark greater than or equal to the threshold value, and the data D1 obtained by the computation in the layer L1, are stored in the DRAM 50. The data D2 obtained by computation in the layer L2 having the data transfer benchmark smaller than the threshold value is not stored in DRAM 50.

Further, in the backward processing, the data D2 used for the computation in the layer L3 is recomputed by the processor 20 which executes the forward processing of the layer L2. The data D3, D1, and D0 used for the computations in layers Loss, L2, and L1 of the backward processing are transferred from the DRAM 50.

In FIG. 7, the data D2 including a relatively large amount of data in the backward processing is recomputed by the forward processing F2 of the layer L2. Because there is no read or write of the data D2 with respect to the DRAM 50, the access time of the DRAM 50 during the entire training is reduced, similar to FIG. 6, and the total access time becomes approximately 1 ms. On the other hand, the computing cost of the forward processing F2 of the layer L2 is high compared to the computing cost of the forward processing F1 of the layer L1. For this reason, the total computing time of the processor 20 during the entire training increases compared to FIG. 5 and FIG. 6, and becomes 2.423 ms. Accordingly, the elapsed time required for the training becomes the total computing time (2.423 ms) of the processor 20, which becomes a bottleneck, and the effective efficiency becomes 75.0% (1.817/2.423) which is deteriorated from the example of FIG. 5.

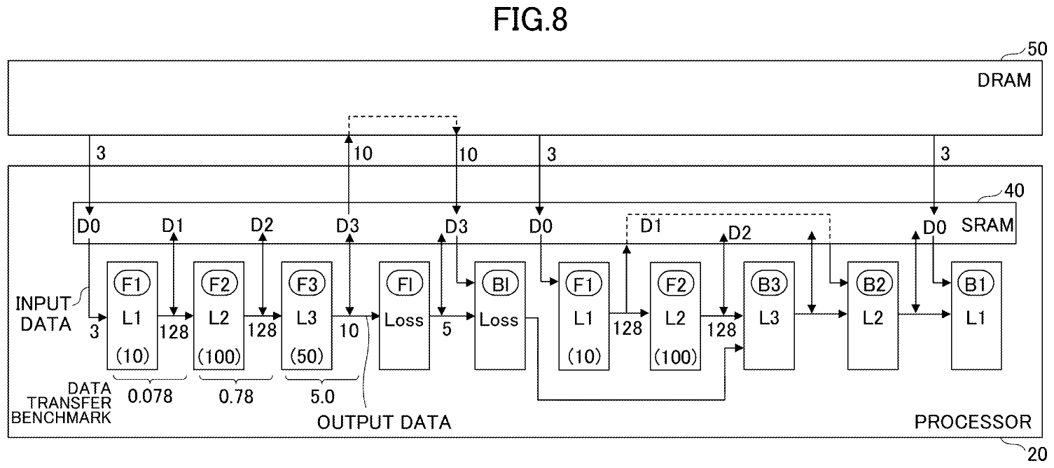

In the training illustrated in FIG. 8, the threshold value of the data transfer benchmark, which determines whether or not the data obtained by the computation in each layer is to be transferred to the DRAM 50, is set to “1.0”. For this reason, in the forward processing, the data D3 obtained by the computation in the layer L3 having the data transfer benchmark which is greater than or equal to the threshold value, is stored in the DRAM 50. The data D1 and D2 obtained by the computations in the layers L1 and L2 having the data transfer benchmark smaller than the threshold value, are not stored in the DRAM 50.

In the backward processing, the data D2 used for the computation in the layer L3 is recomputed by the processor 20 which successively executes the forward processing of the layers L1 and L2. In the backward processing, the data D1 used for computation in the layer L2 is the data stored in SRAM 40 by the forward processing of the layer L1. The data D0 used for the computations in the backward processing of the layers Loss and L1 is transferred from the DRAM 50.

The operation illustrated in FIG. 8 combines the operations of FIG. 6 and FIG. 7, and the computing cost of the processor 20 in the backward processing increases compared to FIG. 7. For this reason, the effective efficiency becomes lower than 75.0% the example of FIG. 7.

Among the examples illustrated in FIG. 5 through FIG. 8, it may be seen that the effective efficiency (99.9%) becomes the highest for the example illustrated in FIG. 6. Thus, by setting the threshold value of the data transfer benchmark, which determines whether or not to transfer the data obtained by the computation in each layer to the DRAM 50, to an appropriate value, the memory bandwidth of the DRAM 50 can be reduced while maximizing the effective efficiency of the processor 20.

Because the amount of data to be transferred to the DRAM 50 can be reduced, it is possible to reduce the capacity of the DRAM 50 provided in the data processing apparatus 100. For example, an inexpensive low-capacity DRAM may be used for the DRAM 50. As a result, the cost of the data processing apparatus 100 can be reduced by using the inexpensive DRAM 50. In other words, the effective efficiency of the processor 20 can be improved, even by the data processing apparatus 100 provided with the DRAM 50 having the low capacity (or reduced capacity).

Further, because the capacity of the DRAM 50 can be reduced, it is possible to reduce the power consumption of the data processing apparatus 100. In addition, the processor 20 having a higher performance may be used when not reducing the memory band width of the DRAM 50.

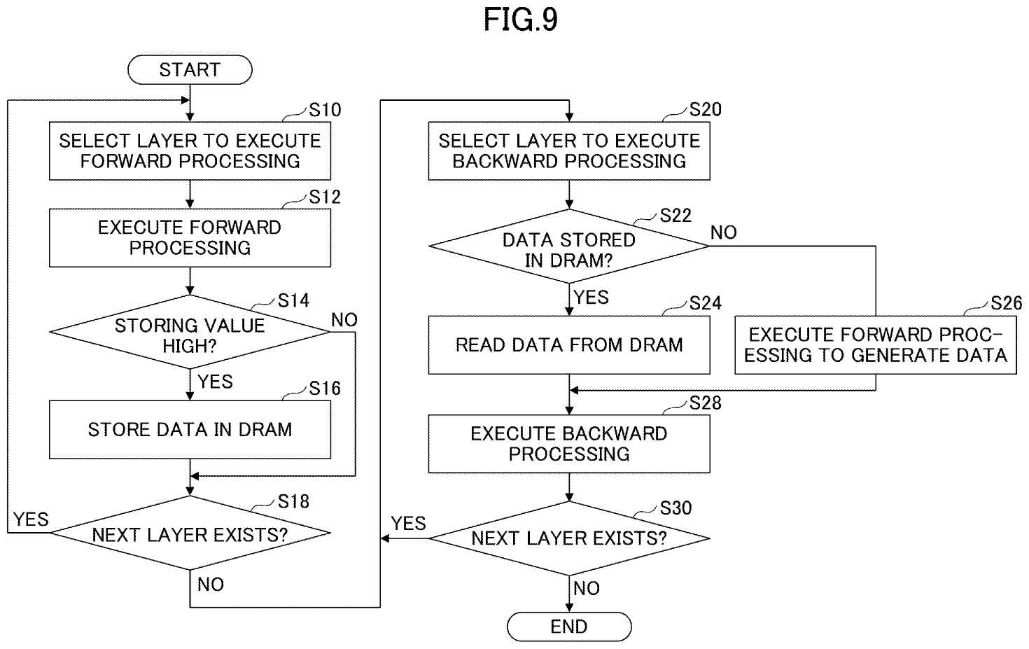

FIG. 9 is a flow diagram illustrating an example of the operation of the data processing apparatus 100 which performs the training of the neural network. For example, the flow illustrated in FIG. 9 may be performed by executing a data processing program by the data processing apparatus 100 (processor 20). FIG. 9 illustrates an example of the data processing method and the data processing program.

First, in step S10, the data processing apparatus 100 selects a layer which is to execute the forward processing. Next, in step S12, the data processing apparatus 100 executes the forward processing of the selected layer.

Next, in step S14, the data processing apparatus 100 determines whether or not the data obtained by the forward processing of the selected layer has a high storing value for storing in the DRAM 50, that is, the data is highly valuable for storage in the DRAM 50. For example, if the data transfer benchmark (refer to FIG. 5 through FIG. 8) in a target layer of the forward processing is greater than or equal to a predetermined data transfer benchmark (that is, the first threshold value) which is preset, the data processing apparatus 100 executes step S16 to store the data in the DRAM 50. The data processing apparatus 100 executes step S18 without storing the data in the DRAM 50 if the data transfer benchmark in the target layer of the forward processing is less than the predetermined data transfer benchmark. The predetermined data transfer benchmark, which is an example of a predetermined storing value, is not necessarily limited to a numerical value.

In step S16, the data processing apparatus 100 stores the data obtained by the forward processing into the DRAM 50, and executes step S18. In step S18, the data processing apparatus 100 executes step S10 if there is a next layer which is to execute the forward processing, and executes step S20 if there is no next layer which is to execute the forward processing.

In step S20, the data processing apparatus 100 selects a layer which is to execute the backward processing. Next, in step S22, the data processing apparatus 100 determines whether or not data to be used for backward processing are stored in the DRAM 50. If the data to be used for the backward processing are stored in the DRAM 50, the data processing apparatus 100 executes step S24. On the other hand, if the data to be used for the backward processing are non-stored data, not stored in the DRAM 50, the data processing apparatus 100 executes step S26.

In step S24, the data processing apparatus 100 reads data to be used for the backward processing from the DRAM 50, and executes step S28. In step S26, the data processing apparatus 100 executes the forward process to generate the data (that is, non-stored data) to be used for backward processing, and executes step S28.

In step S28, the data processing apparatus 100 executes the backward processing of the selected layer, which is the target of the computation, using the data obtained in step S24 or step S26. Next, in step S30, the data processing apparatus 100 executes step S20 if there is a next layer which is to execute the backward processing, and ends the operation illustrated in FIG. 9 if there is no next layer which is to execute the backward processing.

A part of or all of the data processing apparatus 100 according to the embodiment described above may be implemented by hardware, or by information processing of software (or program) executed by a Central Processing Unit (CPU), a Graphics Processing Unit (GPU), or the like. When at least a part of the data processing apparatus 100 is implemented by the information processing of the software, the software which realizes at least a part of the functions of the devices included in the data processing apparatus 100 according to the embodiment described above may be stored in a non-transitory storage medium (that is, a non-transitory computer-readable storage medium), such as a flexible disk, a Compact Disc-Read Only Memory (CD-ROM), a Universal Serial Bus (USB) memory, or the like. In this case, the computer may read the software from the non-transitory storage medium, and execute the information processing of the software. In addition, the software may be downloaded via a communication network. Further, the information processing may be implemented by hardware, by software implemented in circuits such as an Application Specific Integrated Circuit (ASIC), a Field Programmable Gate Array (FPGA), or the like.

A type of the storage medium storing the software, such as the data processing program or the like, is not particularly limited. The storage medium is not limited to a removable storage medium, such as a magnetic disk, an optical disk, or the like, and may be a fixed storage medium, such as a hard disk, a memory, or the like. In addition, the storage medium may be provided internally of the computer, or provided externally to the computer.

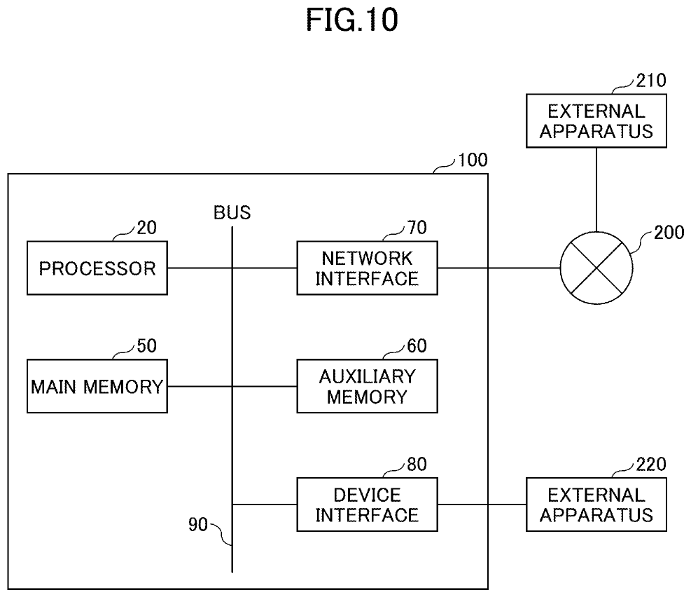

FIG. 10 is a block diagram illustrating an example of a hardware configuration of the data processing apparatus 100 illustrated in FIG. 1. As an example, the data processing apparatus 100 includes a processor 20, a main storage (DRAM) 50, an auxiliary storage (memory) 60, a network interface 70, and a device interface 80, which are connected via a bus 90. The processor 20, the main storage 50, the auxiliary storage 80, the network interface 70, and the device interface 80 may form a computer. For example, the processor 20 may perform the training described in conjunction with FIG. 5 through FIG. 8, by executing the data processing program.

The data processing apparatus 100 includes multiple constituent elements, and the data processing apparatus 100 may include one of each of the constituent elements, or may include two or more identical elements for at least some of the constituent elements. In addition, although FIG. 10 illustrates one data processing apparatus 100, the software may be installed in multiple data processing apparatuses, including the data processing apparatus 100, and each data processing apparatus of the multiple data processing apparatuses may execute the same processing or different processing for at least a part of the software. In this case, each data processing apparatus of the multiple data processing apparatuses, including the data processing apparatus 100, may execute the processing by communicating via the network interface 70 or the like, in the form of a distributed computing. That is, a computing system, which can realize the functions of the data processing apparatus 100, may be configured by executing instructions stored in one or more storages by one or more data processing apparatuses, including the data processing apparatus 100. In addition, one or more data processing apparatuses, including the data processing apparatus 100, provided in a cloud computing system, may execute the processing of the information received from a terminal, and transmit a result of the processing to the terminal.

The operations described in conjunction with FIG. 5 through FIG. 8, and the operation described in conjunction with the flow diagram of FIG. 9 may be performed in parallel, using one or more processors 20, or using multiple computers connected via a communication network 200. In addition, various computations may be distributed among multiple computation cores inside the processor 20, and executed by parallel processing. Moreover, some of or all of the processing, means, or the like of the present disclosure may be executed by utilizing at least one of a processor and a storage provided in a cloud computing system communicable with the data processing apparatus 100 via a network. Accordingly, the computer system including the data processing apparatus 100 may take the form of a parallel computing system including one or multiple computers.

The processor 20 may be an electronic circuit, such as a processing circuit, a processing circuitry, a CPU, a GPU, an FPGA, an ASIC, or the like, including a controller and an arithmetic element of a computer. In addition, the processor 20 may be a semiconductor device or the like, including a dedicated processing circuit. The processor 20 is not limited to the electronic circuit using electronic logic elements, and may be implemented by an optical circuit using optical logic elements. Further, the processor 20 may include computing functions based on quantum computing.

The processor 20 performs a computation processing based on data and software (or program) input from the devices provided internally of the data processing apparatus 100, and outputs a computation result and control signals to the devices provided internally of the data processing apparatus 100. The processor 20 may control the devices forming the data processing apparatus 100 by executing an Operating System (OS), an application program, or the like of the data processing apparatus 100.

The data processing apparatus 100 may be famed by one or multiple processors 20. The processor 20 may refer to one or more electronic circuits provided on a single chip, or may refer to one or multiple electronic circuits provided on two or more chips or on two or more devices. When using multiple electronic circuits for the processor 20, each electronic circuit may communicate by wire or radio, that is, each electronic circuit may perform a cable or wire communication, or a radio or wireless communication.

The main storage 50 is a memory which stores instructions to be executed by the processor 20, various data, or the like, and the information stored in the main storage 50 is read by the processor 20. The auxiliary storage 60 is a memory other than the main storage 50. These storages 50 and 60 refer to arbitrary electronic components capable of storing electronic information, and may be semiconductor memories, for example. The semiconductor memory may be either one of a volatile memory and a non-volatile memory. The storage for storing the various data in the data processing apparatus 100 may be implemented by the main storage 50 or the auxiliary storage 60, or may be implemented by an internal memory, such as the SRAM 40 or the like provided internally of the processor 20.

The configuration of the data processing apparatus 100 is not limited to the configuration illustrated in FIG. 1. Multiple processors 20, or a single processor 20, may be connected with respect to the storage (or memory). Multiple storages (or memories) may be connected (or coupled) with respect to one processor 20 of the multiple processors 20. In a case where the data processing apparatus 100 includes at least one storage (or memory) and multiple processors 20 connected (or coupled) to the at least one storage (or memory), the at least one processor 20 of the multiple processors 20 may be connected (or coupled) to the at least one storage (or memory). In addition, such a configuration may be implemented by a storage (or memory) and a processor 20 included in the multiple data processing apparatuses 100. Further, the configuration may include the storage (or memory) integral with the processor 20, such as a cache memory including a L1 cache, a L2 cache, or the like.

The network interface 70 connects the data processing apparatus 100 to the communication network 200, by wire or wireless. The network interface 70 may use any suitable interface or the like conforming to existing communication standards. The data processing apparatus 100 may exchange information, via the network interface 70, with an external apparatus 210 which is connected via the communication network 200. The communication network 200 may be any one of a Wide Area Network (WAN), a Local Area Network (LAN), a Personal Area Network (PAN), or the like, or may be a combination of such networks, as long as the communication network 200 enables the exchange of information between the data processing apparatus 100 and the external apparatus 210. Examples of the WAN include the Internet or the like. Examples of the LAN include the IEEE 802.11, ETHERNET (registered trademark), or the like. Examples of PAN include the BLUETOOTH (registered trademark), Near Field Communication (NFC), or the like.

The device interface 80 may be a USB or the like which directly connects the data processing apparatus 100 to an external apparatus 220.

The external apparatus 220 may be connected to the data processing apparatus 100 via a network, or may be connected directly to the data processing apparatus 100.

The external apparatus 210 or the external apparatus 220 may be an input device, for example. The input device may be a device, such as a camera, a microphone, a motion capture device, various sensors, a keyboard, a mouse, a touchscreen panel, or the like, for example, and supplies acquired information to the data processing apparatus 100. In addition, the external apparatus 210 or the external apparatus 220 may be a device including an input device, a memory, and a processor, such as a personal computer, a tablet terminal, a smartphone, or the like, for example.

The external apparatus 210 or the external apparatus 220 may be an output device, for example. The output device may be a display device, such as a Liquid Crystal Display (LCD), a Cathode Ray Tube (CRT), a Plasma Display Panel (PDP), an organic Electro Luminescence (EL) panel, or the like, for example. In addition, the external apparatus 210 or the external apparatus 220 may be a speaker or the like which outputs voice or the like, for example. Further, the external apparatus 210 or the external apparatus 220 may be a device including an input device, a memory, and a processor, such as a personal computer, a tablet terminal, a smartphone, or the like, for example.

The external apparatus 210 or the external apparatus 220 may be a storage (or memory). For example, the external apparatus 210 may be a network storage or the like, and the external apparatus 220 may be a storage such as a Hard Disk Drive (HDD). In the case where the external apparatus 220 is the storage (or memory), the external apparatus 220 is an example of a computer-readable storage medium which is readable by a computer, such as the processor 20 or the like.

Moreover, the external apparatus 210 or the external apparatus 220 may be a device having the functions of a part of the constituent elements of the data processing apparatus 100. That is, the data processing apparatus 100 may transmit or receive some of or all of the processing results of the external apparatus 210 or the external apparatus 220.

As described above, according to this embodiment, the memory bandwidth of the DRAM 50 can be reduced while maximizing the effective efficiency of the processor 20, by setting the threshold value of the data transfer benchmark which determines whether or not to transfer the data obtained by the computations in each layer to the DRAM 50. For this reason, a storage capacity (or amount) of the DRAM 50 to be mounted in the data processing apparatus 100 can be reduced, and the cost of the data processing apparatus 100 can be reduced.

The data transfer benchmark may be obtained by dividing the computing cost for each layer by the data size output by each layer. Hence, the data transfer benchmark can easily be obtained, regardless of the complexity of the neural network (or computational graph). The method of determining whether or not to transfer the computation result of the processor 20 to the DRAM 50 based on the data transfer benchmark is not limited to the application to the training of the neural network, and is applicable to other data processing.

As described above, the forward processing is an example of the first processing, and the computations executed in the multiple layers (that is, the multiple internal layers) in the forward processing are an example of the multiple kinds of the first computations. The first data are an example of the data used in the first computation, and the second data are an example of the data (or computation result) obtained by executing the first computation. The backward processing is an example of the second processing, and the computations executed in the multiple layers in the backward processing are an example of the multiple kinds of the second computations. Hence, the first processing and the second processing (that is, the forward processing and the backward processing) may execute the first computation and second computation, respectively, to create a machine learning model, which may be a deep learning model, for example.

In this specification (including the claims), if the expression “at least one of a, b, and c” or “at least one of a, b, or c” is used (including similar expressions), any one of a, b, c, a-b, a-c, b-c, and a-b-c is included. Multiple instances may also be included in any of the elements, such as a-a, a-b-b, and a-a-b-b-c-c. Further, the addition of another element other than the listed elements (that is, a, b, and c), such as adding d as a-b-c-d, is included.

In this specification (including the claims), if the expression such as “data as an input”, “based on data”, “according to data”, or “in accordance with data” (including similar expressions) is used, unless otherwise indicated, a case where various data itself is used as an input and a case where data obtained by processing various data (for example, data obtained by adding noise, normalized data, and intermediate representation of various data) is used as an input are included. If it is described that any result can be obtained “based on data”, “according to data”, or “in accordance with data”, a case where a result is obtained based on only the data is included, and a case where a result is obtained affected by another data other than the data, factors, conditions, and/or states may be included. If it is described that “data is output”, unless otherwise indicated, a case where various data is used as an output is included, and a case where data processed in some way (for example, data obtained by adding noise, normalized data, and intermediate representation of various data) is used as an output is included.

In this specification (including the claims), if the terms “connected” and “coupled” are used, the terms are intended as non-limiting tams that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the tams without being limited.

In this specification (including the claims), if the expression “A configured to B” is used, a case where a physical structure of the element A has a configuration that can perform the operation B, and a permanent or temporary setting/configuration of the element A is configured/set to actually perform the operation B may be included. For example, if the element A is a general-purpose processor, the processor may have a hardware configuration that can perform the operation B and be configured to actually perform the operation B by setting a permanent or temporary program (that is, an instruction). If the element A is a dedicated processor or a dedicated arithmetic circuit, a circuit structure of the processor may be implemented so as to actually perform the operation B irrespective of whether the control instruction and the data are actually attached.

In this specification (including the claims), if a term indicating containing or possessing (for example, “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (that is, an expression using “a” or “an” as an article), the expression should be interpreted as being not limited to a specified number.

In this specification (including the claims), even if an expression such as “one or more” or “at least one” is used in a certain description, and an expression that does not specify a quantity or that suggests a singular number is used in another description (that is, an expression using “a” or “an” as an article), it is not intended that the latter expression indicates “one”. Generally, an expression that does not specify a quantity or that suggests a singular number (that is, an expression using “a” or “an” as an article) should be interpreted as being not necessarily limited to a particular number.

In this specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, states, and/or the like are satisfied, and is not necessarily obtained in the claimed invention that defines the configuration or a similar configuration.

In this specification (including the claims), if a term such as “maximize” is used, it should be interpreted as appropriate according to a context in which the team is used, including obtaining a global maximum value, obtaining an approximate global maximum value, obtaining a local maximum value, and obtaining an approximate local maximum value. It also includes determining approximate values of these maximum values, stochastically or heuristically. Similarly, if a term such as “minimize” is used, they should be interpreted as appropriate, according to a context in which the term is used, including obtaining a global minimum value, obtaining an approximate global minimum value, obtaining a local minimum value, and obtaining an approximate local minimum value. It also includes determining approximate values of these minimum values, stochastically or heuristically. Similarly, if a term such as “optimize” is used, the term should be interpreted as appropriate, according to a context in which the term is used, including obtaining a global optimum value, obtaining an approximate global optimum value, obtaining a local optimum value, and obtaining an approximate local optimum value. It also includes determining approximate values of these optimum values, stochastically or heuristically.

In this specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while another hardware may perform the remainder of the predetermined processes. In this specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In this specification (including the claims), if multiple storage devices (memories) store data, each of the multiple storage devices (memories) may store only a portion of the data or may store an entirety of the data.

Although the embodiments of the present disclosure have been described in detail above, the present disclosure is not limited to the individual embodiments described above. Various additions, modifications, substitutions, partial deletions, and the like may be made without departing from the conceptual idea and spirit of the invention derived from the contents defined in the claims and the equivalents thereof. For example, in all of the embodiments described above, if numerical values or mathematical expressions are used for description, they are presented as an example and are not limited thereto. Additionally, the order of respective operations in the embodiment is presented as an example and is not limited thereto.

What is claimed is:

1. A data processing method comprising:
a first processing which executes a first computation using first data to obtain second data;
a second processing which executes a second computation using the second data; and
storing, in a memory, the second data having a storing value greater than or equal to a predetermined storing value,
wherein the storing value is determined based on a cost of the first computation and a size of the second data.

2. The data processing method as claimed in claim 1, wherein
the storing value is computed by dividing the cost of the first computation by the size of the second data, and
the second data having the storing value greater than or equal to a first threshold value is stored in the memory.

3. The data processing method as claimed in claim 1, wherein
the first processing successively executes multiple kinds of first computations to obtain the second data,
the second processing successively executes multiple kinds of second computations respectively corresponding to the multiple kinds of the first computations, and
the second computation is executed by
reading the second data from the memory, if the second data to be used is stored in the memory, and
using the second data obtained by executing the first computation corresponding to the second data to be used, if the second data to be used is not stored in the memory.

4. The data processing method as claimed in claim 1, wherein
the first processing is a forward processing of a neural network, and
the second processing is a backward processing of the neural network.

5. The data processing method as claimed in claim 1, wherein the second data, determined to be stored in the memory based on the storing value, is stored in the memory which is coupled to an arithmetic element, including multiple computing elements configured to execute the first computation and the second computation, and an internal memory.

6. A data processing apparatus comprising:
an arithmetic element including multiple computing elements configured to execute a first computation using first data to obtain second data, and to execute a second computation using the second data; and
a memory coupled to the arithmetic element,
wherein the arithmetic element stores, in the memory, the second data having a storing value greater than or equal to a predetermined storing value, and
wherein the storing value is determined based on a cost of the first computation and a size of the second data.

7. The data processing apparatus as claimed in claim 6, wherein
the arithmetic element computes the storing value by dividing the cost of the first computation by the size of the second data, and
the arithmetic element stores the second data having the storing value greater than or equal to a first threshold value in the memory.

8. The data processing apparatus as claimed in claim 6, wherein
the multiple computing elements successively execute multiple kinds of first computations to obtain the second data,
the multiple computing elements successively execute multiple kinds of second computations respectively corresponding to the multiple kinds of the first computations, and
the second computation, executed by the multiple computing elements,
reads the second data from the memory, if the second data to be used is stored in the memory, and
uses the second data obtained by executing the first computation corresponding to the second data to be used, if the second data to be used is not stored in the memory.

9. The data processing apparatus as claimed in claim 6, wherein
the first computation is included in a forward processing of a neural network, and
the second computation is included in a backward processing of the neural network.

10. A non-transitory computer-readable storage medium having stored therein a data processing program which, when executed by a computer, causes the computer to perform a process comprising:
performing a first processing which executes a first computation using first data to obtain second data;
performing a second processing which executes a second computation using the second data; and
storing, in a memory, the second data having a storing value greater than or equal to a predetermined storing value,
wherein the storing value is determined based on a cost of the first computation and a size of the second data.

11. The non-transitory computer-readable storage medium as claimed in claim 10, wherein
the storing value is computed by dividing the cost of the first computation by the size of the second data, and
the second data having the storing value greater than or equal to a first threshold value is stored in the memory.

12. The non-transitory computer-readable storage medium as claimed in claim 10, wherein
the first processing successively executes multiple kinds of first computations to obtain the second data,
the second processing successively executes multiple kinds of second computations respectively corresponding to the multiple kinds of the first computations, and
the second computation is executed by
reading the second data from the memory, if the second data to be used is stored in the memory, and
using the second data obtained by executing the first computation corresponding to the second data to be used, if the second data to be used is not stored in the memory.

13. The non-transitory computer-readable storage medium as claimed in claim 10, wherein
the first processing is a forward processing of a neural network, and
the second processing is a backward processing of the neural network.

14. The data processing method as claimed in claim 1, wherein the first processing and the second processing execute the first computation and the second computation, respectively, to create a machine learning model.

15. The data processing method as claimed in claim 1, wherein the memory is a Dynamic Random Access Memory (DRAM).

16. The data processing method as claimed in claim 5, wherein the internal memory is a Static Random Access Memory (SRAM).

17. The data processing method as claimed in claim 16, wherein the memory is a Dynamic Random Access Memory (DRAM).

18. The data processing apparatus as claimed in claim 6, wherein the arithmetic element executes the first computation and the second computation, to create a machine learning model.

19. The data processing apparatus as claimed in claim 6, wherein the memory is a Dynamic Random Access Memory (DRAM).

20. The data processing apparatus as claimed in claim 19, wherein the arithmetic element includes an internal memory which is a Static Random Access Memory (SRAM).
